(19) United States
(12) Patent Application Publication
(10) Pub. No.: US 2015/0330123 A1
(43) Pub. Date: Nov. 19, 2015

(54) LOCK LATCH

(71) Applicant: Wan Lai Liau, Taipei City (TW)

(72) Inventor: Wan Lai Liau, Taipei City (TW)

(21) Appl. No.: 14/281,137

(22) Filed: May 19, 2014

(51) Int. Cl. E05C 3/12

(52) U.S. Cl. CPC E05C 3/12

(57) ABSTRACT

A lock latch is provided with in combination a lock assembly including a knob at one end, a curved member, a hollow, rotatable shaft inwardly projecting out of the other end, and two opposite flats formed on an outer surface of the shaft; a seat including an oval projection having a through hole, a recess in an inner surface of the projection, and raised blocks on the recess; and two end members; a strike plate secured to the seat; and two opposite elastic members disposed between the raised blocks at one end of the recess and the raised blocks at an other end of the recess respectively. The shaft is inserted through the through hole, a fastener is driven through the shaft to have one end fastened, and an outer surface of the shaft other than the flats are clamped by the elastic members in an unlocked position.

### BACKGROUND OF THE INVENTION

1. Field of the Invention

The invention relates to lock latches for closures (e.g., windows or patio doors) and more particularly to a lock latch with improved characteristics.

2. Description of Related Art

A conventional lock latch is provided to limit the opening of a closure (e.g., window or patio door) beyond an adjusted position. A simple integral notched plate as one element and a swiveled pin as a second element provide the structure, each held by fasteners which have substantially resistance to any forcing of the closures.

Notwithstanding the prior disclosure, the invention is neither taught nor rendered obvious thereby.

### SUMMARY OF THE INVENTION

It is therefore one object of the invention to provide a lock latch comprising in combination a lock assembly including a main body, a knob at one end of the main body, a curved member extending out of the main body, a hollow, rotatable shaft inwardly projecting out of an other end of the main body, and two opposite flats formed on an outer surface of the hollow, rotatable shaft; a seat including an intermediate, oval projection having a through hole, a recess in an inner surface of the intermediate, oval projection, and a plurality of raised blocks on the recess; and two end members; a strike plate releasably secured to the seat; and two opposite elastic members disposed between the raised blocks at one end of the recess and the raised blocks at an other end of the recess respectively; wherein the hollow, rotatable shaft is inserted through the through hole, a fastener is driven through the hollow, rotatable shaft to have one end fastened by a fastening member, and an outer surface of the hollow, rotatable shaft other than the flats are clamped by the opposite elastic members in an unlocked position; and wherein a clockwise rotation of the hollow, rotatable shaft inserts a portion of the curved member into the strike plate to lock the lock assembly with the flats being clamped by the opposite elastic members.

The above and other objects, features and advantages of the invention will become apparent from the following detailed description taken with the accompanying drawings.

### BRIEF DESCRIPTION OF THE DRAWINGS

FIG. 1 is an exploded perspective view of a lock latch according to the invention;

FIG. 2A, FIG. 2B, and FIG. 2C are front, longitudinal sectional, and rear views of the seat respectively;

FIG. 3 is a longitudinal sectional view of the washer;

FIG. 4 is an exploded view of the lock latch;

FIG. 5A and FIG. 5B are perspective views of second and third embodiments of the fastener respectively;

FIG. 6 is a front view of the assembled lock assembly and the strike plate to be ready for locking or unlocking;

FIG. 7 is a side elevation of FIG. 6;

FIG. 8 is a rear view of FIG. 6; and

FIG. 9 is a sectional view taken along line 9-9 of FIG. 6.

### DETAILED DESCRIPTION OF THE INVENTION

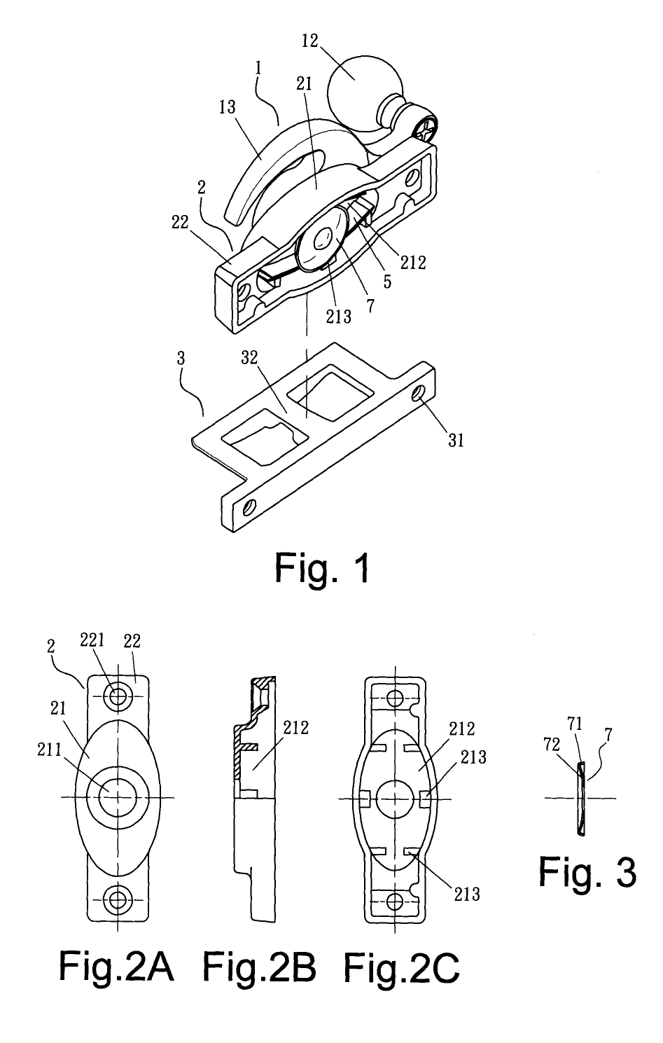

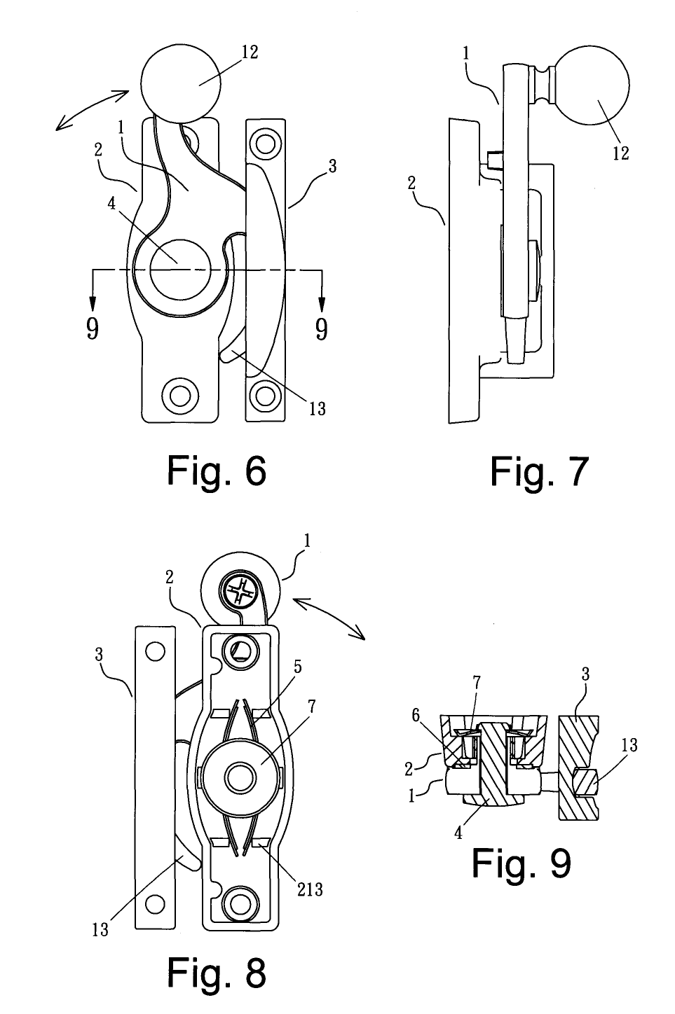

Referring to FIGS. 1 to 9, a lock latch in accordance with the invention comprises the following components as discussed in detail below.

An elongated lock assembly 1 comprises a main body 11, a knob 12 secured to one end of the main body 11, a curved member 13 integrally formed with the main body 11 with an elongated space separating itself from the main body 11, a rotatable shaft 14 inwardly projecting out of a central portion of the other end of the main body 11, a channel 15 through the rotatable shaft 14, and two opposite flats 16 formed on an outer surface of the rotatable shaft 14.

An elongated seat 2 comprises an intermediate oval projection 21 including a central through hole 211, a recess 212 on an inner surface of the projection 21, and a plurality of raised blocks 213 in the recess 212; and two end members 22 each including a through hole 221.

An elongated strike plate 3 comprises two threaded holes 31 at both ends respectively, and a frame member 32 extending laterally between the threaded holes 31. Two opposite sets of two elastic plates 5 are provided between the raised blocks 213 at one end of the recess 212 and the raised blocks 213 at the other end of the recess 212 respectively. Inner one of the elastic plates 5 of either set is slightly shorter than outer one thereof for increasing performance (see FIG. 8). Further, the intermediate raised blocks 213 hold the sets of elastic plates 5 in place. A disc-shaped washer 7 comprises a flange edge 71 and a raised central portion 72.

In assembly, a washer 6 is put on the rotatable shaft 14 which is in turn inserted through the through hole 211 to be adjacent to the washer 7 fastened in the seat 2. A fastener 4 is driven through the channel 15 and the washer 7 to have one end secured to the washer 7. The outer surface of the rotatable shaft 14, other than the flats 16, is clamped by the two sets of elastic plates 5. Thus, the lock assembly and the seat 1 are assembled. Further, screws (not shown) are driven through the threaded holes 31 to secure the strike plate 3 to a closure (e.g., window frame or patio door frame).

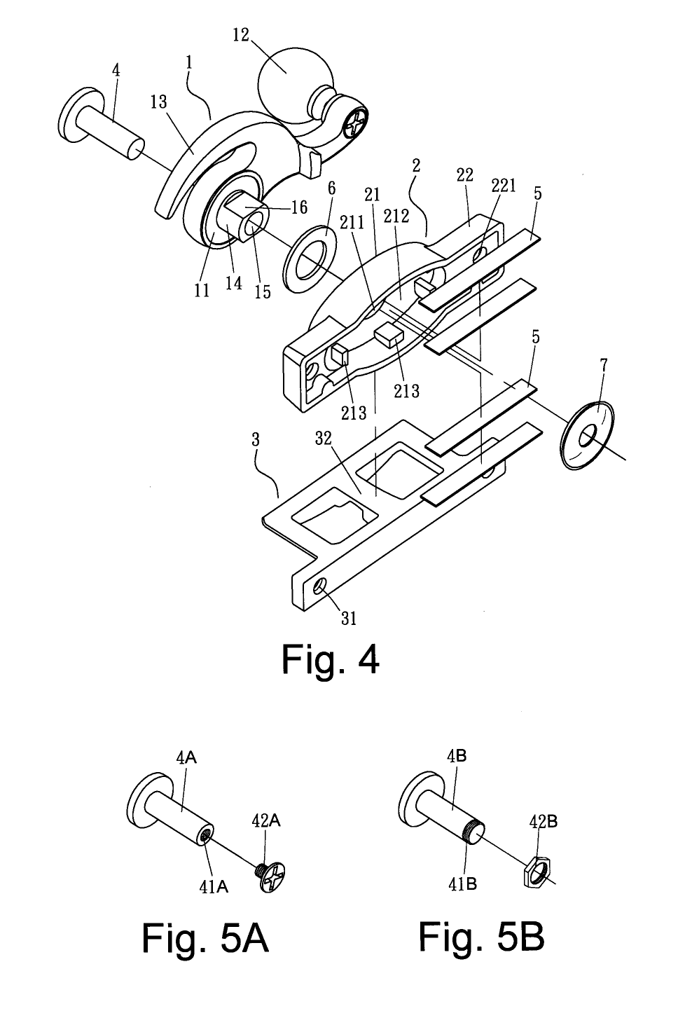

The fastener 4 can be implemented, alternatively to a rivet (see FIG. 4), either by a first threaded fastener 4A including a threaded hole 41A in its shank and a screw 42A driven into the threaded hole 41A for fastening (see FIG. 5A), or by a second threaded fastener 4B including external threads 41B on one end its shank and a nut 42B threadedly put on the threads 41 B for fastening (see FIG. 5B).

In use, a user may hold and clockwise turn the knob 12 (i.e., the rotatable shaft 14) to insert a portion of the curved member 13 through the frame member 32 for locking. In the locked position, the flats 16 are clamped by the opposite sets of elastic plates 5. Further, a click can be heard when the flats 16 are clamped by the opposite sets of elastic plates 5 in the locking operation. To the contrary, a counterclockwise turn of the knob 13 can unlock the lock latch of the invention.

While the invention has been described in terms of preferred embodiments, those skilled in the art will recognize that the invention can be practiced with modifications within the spirit and scope of the appended claims.

1. A lock latch comprising in combination:
a lock assembly including a main body, a knob at one end of the main body, a curved member extending out of the main body, a hollow, rotatable shaft inwardly projecting out of an other end of the main body, and two opposite flats formed on an outer surface of the hollow, rotatable shaft;
a seat including an intermediate, oval projection having a through hole, a recess in an inner surface of the intermediate, oval projection, and a plurality of raised blocks on the recess; and two end members;
a strike plate releasably secured to the seat; and
two opposite pairs of elastic members disposed between the raised blocks at one end of the recess and the raised blocks at another end of the recess respectively;
wherein the hollow, rotatable shaft is inserted through the through hole, a fastener is driven through and secured to the hollow, rotatable shaft, and an outer surface of the hollow, rotatable shaft other than the flats are clamped by the opposite elastic members in an unlocked position; and
wherein a clockwise rotation of the hollow, rotatable shaft inserts a portion of the curved member into the strike plate to lock the lock assembly with the flats being clamped by the opposite elastic members.

2. The lock latch of claim 1, wherein an inner one of each pair of elastic members is shorter than an outer one of each pair of elastic members.
